(19) United States
(12) Patent Application Publication
(10) Pub. No.: US 2014/0279685 A1
(43) Pub. Date: Sep. 18, 2014

(54) SYSTEM AND METHOD FOR MONETIZING AN EXTERNALITY

(71) Applicants: Stratis Apostle Voutsas, McLean, VA (US); Georgia Ioannis Papadopoulos, McLean, VA (US)

(72) Inventors: Stratis Apostle Voutsas, McLean, VA (US); Georgia Ioannis Papadopoulos, McLean, VA (US)

(21) Appl. No.: 13/836,952

(22) Filed: Mar. 15, 2013

(51) Int. Cl. G06Q 40/06

(52) U.S. Cl. CPC G06Q 40/06
USPC 705/36 R

(57) ABSTRACT

A method is disclosed that includes calculating by an intermediary, using a computing apparatus, an estimated social dividend achieved as a monetization of an externality accruing to the public. The method further includes advancing funds, by a partaking entity, related to the externality. The method also includes paying, by the intermediary, the social dividend as estimated. The method further includes receiving, by the partaking entity, an incentive for advancing funds related to the externality.

### TECHNICAL FIELD

The technical field relates in general to funding a project or an undertaking which benefits the public for an associated externality. More specifically, the technical field relates to monetizing a proffered externality which can be used to further incentivize private funding for the project or undertaking or other projects and undertakings

### BACKGROUND

Because of regulatory and market constraint the funding options for endeavors with public benefit are limited. Governments, organizations and other entities often face a challenge in undertaking projects that benefit the public. That is to say, government officials at all levels would like to undertake projects that result in a benefit to the public at large. However there is simply not enough money in the public treasuries, nor sufficient borrowing capacity, nor are there ready sources of financing willing to accept a lower than market yield, such that beneficial projects to the public can be undertaken.

Governments (as well as other entities) would like to find a way to encourage private funding of public projects, but as has been documented in at least one federal study (“New Economic Analysis of Infrastructure Investment, a Report Prepared by the Department of the Treasury with the Council of Economic Advisers, Mar. 23, 2012”), a lack of private investment in infrastructure and other public projects is in large part due to current methods of funding infrastructure. These methods lack effective mechanisms to attract and repay direct private investment. In addition, the private benefit for private investors is actually less than the benefit for the public as whole because of positive externalities accruing from infrastructure or other projects.

To clarify, an externality is defined as a consequence of an economic activity that is experienced by unrelated third parties. Thus for example, if a first party homeowner pays cash to a second party landscape company who plants several trees on the first party homeowner's real property, a third party neighbor who enjoys the beauty of the new trees experiences an externality. That is to say, the third party neighbor is not involved in the economic activity between the first party homeowner and the second party landscape company, but nonetheless experiences a benefit.

It should be quickly noted that as used herein, the words “project” and “undertaking” are generally interchangeable, with the exception being that an undertaking can be a subset of a project. That is to say, the embodiments described herein do not always necessarily require completion of a project by an end user. Rather sometimes just a partial element of a project (an undertaking) on the part of an end user creates a monetizable externality.

In the context of funding infrastructure, for example, externalities accrue to the public as a result of an agreement between an infrastructure developer (an end user government entity or the like) and a partaking entity who provides the resources for the infrastructure development. For example, when a local government builds a bridge using private funding, not only is there a bridge built that is convenient to use, but the possibility exists that jobs may be created as a result of increased traffic flow across the bridge. When these jobs actually come into existence, an externality has accrued to the public.

It has been noted in an article titled “What Are Externalities” by Thomas Helbling, IMF-Finance-Development-Magazine-December-2010-Issue, on page 49, that “Externalities pose fundamental economic policy problems when individuals, households, and firms do not internalize the indirect costs of or the benefits from their economic transactions. The resulting wedges between social and private costs or returns lead to inefficient market outcomes. In some circumstances, they may prevent markets from emerging.” Stated another way in the context of private financing of public projects, private investors do not realize the public benefit attained as a result of their investment and the public (via the end user government entity) does not realize the cost. It is submitted that if private investors were able to realize the externalities accruing to the public in a return on their private investments, there would be an increase in the amount of private financing of undertakings and projects designed to benefit the public.

The present disclosure thus presents systems and methods for monetizing an externality as a social benefit which becomes a negotiable currency. In the end, the cost of obtaining funds to the public borrower is actually lowered. Additionally, private investor returns are increased, such that private financing of projects and undertakings benefiting the public should rise.

### SUMMARY

According to an aspect, there is provided a method comprising calculating by an intermediary, using a computing apparatus, an estimated social dividend achieved as a monetization of an externality accruing to the public. The method further comprises advancing funds, by a partaking entity, related to the externality. The method further comprises paying, by the intermediary, the social dividend as estimated. The method further comprises receiving, by the partaking entity, an incentive for having advanced the funds related to the externality.

According to another aspect, there is provided a method comprising receiving information about a proffered externality accruing to the public for an undertaking. The method further comprises calculating, with a computing apparatus, based on the received information, a social dividend as a monetization of at least a part of the proffered externality. It should be noted that these embodiments are exemplary, and other embodiments may be disclosed herein.

It should also be noted that the purpose of the abstract is to enable the U.S. Patent and Trademark Office and the public generally, and especially the practitioners in the art who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating money flow in a system for monetizing a proffered externality and incentivizing private funding of an undertaking or project.

FIG. 2 is a block diagram illustrating a network configuration of a computer based system for monetizing a proffered externality and incentivizing private funding of an undertaking or project.

FIG. 3 is a bubble flow chart illustrating a method for monetizing a proffered externality and incentivizing private funding of an undertaking or project.

FIG. 4 is table illustrating variables and their values for use with a working example of a method for monetizing a proffered externality and incentivizing private funding of an undertaking or project.

FIG. 5 is a table of calculations, using the variables and values of FIG. 4, in a working example of a method for monetizing a proffered externality and incentivizing private funding of an undertaking or project.

### DETAILED DESCRIPTION

In overview, the present disclosure concerns systems and methods of monetizing externalities accruing to the public. As described further below, each entity that is a part of the system may be represented by a networked apparatus for performing the functionality of the entity as described herein. The actions of a partaking entity, an investment vehicle, an intermediary, a project sponsor, and a project end user, taken together, facilitate the monetizing of a proffered externality and incentivizing private funding of an undertaking or project.

The instant disclosure is thus provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

As further discussed herein below, various inventive principles and combinations thereof are advantageously employed to monetize a proffered externality and incentivize private funding of an undertaking or project. Referring now to FIG. 1, which is a diagram illustrating money flow in a system for monetizing a proffered externality and incentivizing private funding of an undertaking or project, will be discussed and described. The externality monetization system 100 comprises a partaking entity 101, a project end user 103, a project sponsor 105, an intermediary entity 109, and an investment vehicle 107.

The project end user 103 is considered to be a proponent of the project, or stated another way, the end user 103 has the ultimate responsibility for physically completing or finalizing a project or undertaking The project end user 103 may be a developer of the project. Project end users 103 may typically be governmental entities, but they are also various profit (for example, sports franchises) or non-profit (for example, neighborhood development associations) organizations. The project end user 103 may be aware of various projects that will be beneficial to the public. However, sometimes every day governance may take precedence over long-term considerations related to projects that produce benefits and externalities.

Thus many times, the function of studying possible projects will be performed by the project sponsor 105. The project sponsor 105 may be a local entity that is interested in seeing public works and public benefit achieved. Typically the project sponsor 105 is a non-profit entity or non-governmental organization (NGO) working in association with or under the auspices of a government who may be the end user 103.

The starting point for monetizing a proffered externality may include an initial assessment of the value of associated externalities of a project. This function typically is left with the project sponsor 105 who evaluates projects using standardized metrics and procedures to determine a monetized value of the externalities of the project. Typically the project sponsor 105 will prepare detailed analyses of various projects with a full statistical treatment. Ultimately, the project sponsor 105 determines and identifies which undertakings or projects should be pursued by the end user 103 and/or be submitted for approval to be part of the externality monetization system 100.

Although the project sponsor 105 may perform initial assessments of the viability of a project or undertaking given the externalities of the project, it is the intermediary entity 109 that validates calculations of the project sponsor 105. The intermediary entity 109 actually certifies various projects and undertakings as having externalities that are worth a particular present value. That is to say, the intermediary entity 109 receives information about a proffered externality accruing to the public for an undertaking or project, from the project sponsor 105 or project end user 103 or other proponent, and calculates a monetization of the proffered externality using applicable, standardized metrics and procedures. The monetization of a particular project or undertaking can be described as a “social dividend” that can be paid. Another interchangeable expression for “social dividend” is “quantifiable public benefit.”

It should be noted that the intermediary entity 109 is likely, but not limited to, a non-profit style organization that has expertise in public policy and development. An example of a possible intermediary entity may be an arm of a higher education institution that specializes in government studies. The intermediary entity 109 may take a variety of forms, including a natural person, a trust, a proprietorship, a partnership, a company, a corporation, a pass-thru entity, a non-governmental organization, and a governmental organization, and any other legal entity qualified to act as an intermediary entity 109. The intermediary entity 109 may be registered as a 501(c)(3) charity. In the monetization system 100, the intermediary entity 109 acts as a fiduciary charged with protecting the value of the externality.

It should further be understood that the “social dividend,” which is a quantifiable, present value of an externality, may actually create a new class of asset, as discussed further below. Once a project is certified by the intermediary entity 109 in a formal manner as having a social dividend, that particular social dividend is, in effect, an asset which can be used to secure funding for the particular project with which the social dividend is associated. Any portion of an externality that is not security may be used as resource for some other unrelated project. It should be further understood that the social dividend can be traded or transferred. In some sense the intermediary entity 109 acts in the capacity of a “bank” for social dividends, ongoingly receiving deposits of the quantifiable public benefit and ongoingly paying the social dividend to project sponsors 105. Because of the characteristics of the social dividend and the function of the intermediary entity 109, it should be clearly understood that a partaking entity 101 may provide funds to an end user 103 secured by a social dividend that may or may not be associated with any particular undertaking or project of the end user 103. That is to say, advanced funds may be secured by any certified or validated social dividend that is not then current securing an advance.

The social dividend of a project is typically paid to the project sponsor 105 who receives the social dividend for identifying the project and preparing the relevant statistics. The project sponsor 105 then further provides an incentive to the partaking entity 101 to secure funding for the project. Of course, funding the project is another part of the externality monetization system 100 that is performed with particularity. Once a project is certified by the intermediary entity 109 as paying a social dividend, the end user 103 submits the project for underwriting to the partaking entity 101.

The partaking entity 101 does not actually provide its own funds to the end user 103. Rather, the partaking entity 101 is in some way another intermediary broker who secures funding for one or more projects or undertakings by issuing specialized financial instruments that are secured by the underwriting standards of the partaking entity 101. It should be understood that the financial instruments are not necessarily issued on a project-by-project basis unless such issuance is justified. Rather financial instruments may be underwritten and pooled by category, risk rating, term, or by any other combination of underwriting and pooling standards of the partaking entity 101.

The partaking entity 101 as mentioned above eventually receives an incentive, usually by taking into account the social dividend benefit expected to be paid. The incentive is paid 141 in order to secure below market advances from the partaking entity 101. However, the partaking entity 101 may alternatively 129 advance funds at a sufficient rate to accomplish its underlying financial instrument yield objectives to the project sponsor 105 who, in turn 125, makes advances to the end user 103 under the project sponsor's 105 terms and conditions. In those instances, the incentive is not paid to the partaking entity 101. Rather, the partaking entity 101 receives 131 payments in an amount sufficient to satisfy its underlying financial instrument yield objectives, after taking account all cost and fee considerations that effect the efficient flow of capital amongst all participants, from the project sponsor 105. Alternatively, the intermediary entity 109 may also be the project sponsor 105 of an undertaking and may distribute the incentive directly (not shown) to the partaking entity 101.

The partaking entity 101 is typically an entity registered to issue financial instruments through a global and, where limited by situs regulations, its customary nationwide sales network such as a broker-dealer network. The partaking entity 101 may be a bank, investment banker/house, insurance company, mutual fund, REIT, and the like depending on its global situs and the respective regulatory constraints. Essentially any entity that can sell a known, or yet unknown, equity, participatory, obligation, interest or dividend yielding instrument or security to private capital to accomplish the monetization of a proffered externality as envisioned herein may qualify to be the partaking entity 101.

The partaking entity 101 may issue a type of security known as a face-amount certificate, as defined in the Investment Company Act of 1940. The partaking entity 101 may also issue regulated or purpose designed financial instruments to allow for the efficient flow of capital amongst the participating entities 101, 107, 109, and 105 or other proponent of the externality. The special financial instruments issued by the partaking entity 101 have certain earnings and redemption attributes and properties that are unique and designed to compensate private capital, for the externalities delivered to society, via the intermediary entity 109 after taking account of all cost and fee considerations to effect the efficient flow of capital amongst all participants. That is to say, the financial instruments offered by the partaking entity 101 will ultimately have a higher than market rate of return for similar instruments because of the monetized externality. It would be expected that the rate of return on financial instruments issued by the partaking entity 101 with an externality ratio of 2:1 would yield approximately 100% over the life of the instrument. The financial instruments are quantifiable commitments of the partaking entity 101.

The partaking entity 101 will only issue the special financial instruments to investors and investment vehicles 107 that have been qualified to receive the instruments. Specifically, in order to control ownership of the instruments issued by the partaking entity 101, a settlement meeting should be held (similar to a real estate settlement) where the investment vehicle 107 is approved to receive the financial instruments. The reason for such a particular type of proceeding is that the investment vehicle 107 must indicate that the intermediary entity 109 will be a beneficiary of the investment vehicle 107. The investment vehicle 107 can take many forms including a trust, a corporation, a pass-thru entity, a non-governmental organization, and a governmental organization. The investment vehicle 107 may be registered as a 501(c)(3) charity. The investment vehicle 107 may be a special purpose vehicle or a special purpose entity.

A clear example of such an investment vehicle 107 that names the intermediary entity 109 as a beneficiary would be a split-interest charitable trust that is one of a charitable remainder trust, charitable lead trust, and a hybrid charitable instrument. Private capital holders choose charitable trusts to achieve a variety of different financial goals which are beyond the scope of this disclosure. An investor or asset holder will create and fund a charitable trust, which is then administered by a trustee.

In the present externality monetization system 100, the investment vehicle 107 will typically have an administrator (for example, a trustee) appointed at the settlement meeting. The administrator will receive the funds from an investor of private capital that funds the investment vehicle 107. The administrator will then name the intermediary entity 109 as beneficiary. The administrator of the investment vehicle 107 will transfer cash to the partaking entity 101 in exchange for the financial instruments of the partaking entity 101. The partaking entity 101 at the settlement transfers the special financial instruments to the investment vehicle 107.

Now that each of the components of the externality monetization system 100 has been initially described, the flow of money in the monetization system 100 can more easily be understood. As mentioned above, the financial instruments issued by the partaking entity 101 are usually pooled and not related to a particular project. Thus, in an ongoing manner, the partaking entity 101 is seeking investors with private capital 114 to provide 113 funds into investment vehicles 107.

Once the investment vehicle 107 is created as described above, the investment vehicle 107 purchases 115 financial instruments by transferring funds to the partaking entity 101. The partaking entity 101 then receives 117 funds. The partaking entity 101 issues 117 financial instruments, and proceeds to transfer 119 the financial instruments to the investment vehicle 107.

The issuance of the special financial instruments by the partaking entity 101 is now discussed in greater detail. As indicated above, the partaking entity 101 will place projects into pools according to risk classification. That is, certified projects are underwritten and pooled by category, risk rating, loan term, and/or any combination of the above. The partaking entity 101 then creates financial instruments for each pool.

As indicated, it is expected then that certain projects or undertakings will have more risk than other. For example, a project that involves upgrading a school would normally be classified as having less risk than a project related to construction of a metro rail system. As would be understood, an existing school needing upgrades is probably less subject to the influence of, for example, weather and other environmental conditions. Estimations of both the timeliness of completion of the projects as well as estimates of the externalities are more predictable for the school upgrade project than for the metro rail project. However, it should also be clear that the externalities associated with a metro rail project will usually tend to be of a much larger scale than a project to upgrade a school.

The partaking entity 101 will pool projects according to risk classification because of the degrees of risk in differing projects. In pooling project by risk, each project will be assigned a grade related to the degree of risk of completion as well as to a degree of scale of monetized externality. The partaking entity 101 will then pool the projects according to some combination of these grades. Thus the partaking entity 101 may pool the projects according to a degree of completion risk; according to a degree of a scale of externality; or according to a combined grade of both the completion risk and the scale of externality.

If the partaking entity 101 pools projects according to a combined grade of completion risk and scale of externality, it should be understood that there would be a weighting of the above two factors. The partaking entity would determine the degree of importance of completion risk and scale of externality. The weighting ultimately would effect the exact break down in pooled projects. Of course, the pooling can be based on something other than risks, including loan term or project classification.

As pooling is ongoingly completed, it is expected that the financial instruments for social dividend project pools will then be issued on a regular basis, e.g., monthly, to achieve investor return objectives. The financial instruments could be offered through regulated channels by investment class. The instruments may be issued in any of a variety of different forms, including those issued by the various entities enumerated and described above with reference to the partaking entity.

Simultaneous to the ongoing establishment of investment vehicles 107 and issuance and transfer 117, 119 of financial instruments, the project sponsor 105 provides identifying information to the intermediary entity 109 about a project that will accrue externalities 139 to the public. The intermediary entity 109 will, where appropriate, certify 122 that an identified project by the project sponsor 105 carries sufficient proffered externality from which a social dividend can be paid.

The identification and certification 122 of proffered 139 externalities according to the present invention presents a different way of using externalities by converting its previously non-monetizable attributes into as yet undiscovered monetizable commodity. Specifically, when an externality is certified 122 by the intermediary entity 109 as providing a public benefit, then the public benefit becomes a resource that may be converted into a social dividend when monetized 137 by investment vehicle 107 and/or by other methods of sourcing funds by the intermediary entity 109.

If the above-mentioned bridge brings 100 jobs to a suburban region, and a present value of each new job created is defined to be $50,000 in income per job, it might be said that the quantified externality, known as the social dividend, of a project titled “Build Bridge A” is, for simplicity sake, $5,000,000. In FIG. 1, the project sponsor 105 identifies and proffers 139 the “Build Bridge A” project as being worth $5,000,000. The project sponsor 105 will provide all the research, analyses, and statistics that demonstrate this valuation.

The role of the intermediary entity 109 as a fiduciary requires that the intermediary entity 109 independently verify the valuation of the “Build Bridge A” project as being worth $5,000,000. The intermediary entity 109 will independently process all the data and financial information identified by the project sponsor 105. Similar to the way banks underwrite undertakings, the intermediary entity 109 issues a document certifying that the project or undertaking of “Build Bridge A” provides an externality worth $5,000,000. This document is similar to a conventional receipt in idea, which is that it is evidence that a particular project is worth a particular social dividend.

Of course, such a document provides for benchmarks of the progress of project as accruing the externality. Thus, the document certifies that when the entire “Build Bridge A” project is complete, the $5,000,000 can be paid as the social dividend. If a portion of the “Build Bridge A” project is complete, the partial social dividend is a receivable.

Thus, it should be clear that when the intermediary entity 109 completes the verification process and certifies the “Build Bridge A” project as providing an externality worth $5,000,000, the social dividend may then be treated as an asset. That is to say, the social dividend of a certified project can be used to secure financing, and can additionally be assigned or transferred or traded or gifted. The social dividend is an asset in a classical sense.

When the intermediary entity 109 certifies 122 a project as producing an externality of a certain value, the certification is essentially a deposit of a receivable. The intermediary entity 109 holds the certification until either the receivable becomes cash when the intermediary receives funds as the beneficiary of an investment vehicle 107, or the value of the receivable is used as a security for an obligation. Succinctly put, the intermediary entity 109 is an “externality depository entity” that accepts externalities as deposits, as evidenced by a receipt of a certificate 122 representing the monetizable value to be paid out in the form of social dividend when funds become available to the intermediary entity 109.

Once a project has been certified 122 as having sufficient externality from which a social dividend can be paid, the partaking entity 101 will advance 121 funds at lower than market rate of return to the project end user 103. As the project progresses, the end user 103 meets its commitment payments 123 on an instrument yielding a below market return to the partaking entity 101. The partaking entity 101 receives the agreed to 123 commitment. The partaking entity 101 receives and pools 133 the receipts from one or more undertakings or projects, and meets its financial commitments 135 (net of costs incurred by the partaking entity 101) on the financial instruments held by the investment vehicle 107. The investment vehicle 107 then further meets its beneficiary commitment (net of costs incurred by investment vehicle 107), making 137 beneficiary payments to the intermediary entity 109 as the beneficiary of the investment vehicle 107. It should be noted that since the funds are usually pooled by the partaking entity 101 and there are costs incurred by the partaking entity 101, the commitments kept and payments made 123 by the end user 103 is generally not equivalent to the commitments kept and payments made 135 by the partaking entity 101.

As mentioned above, the partaking entity 101 may alternatively route advances to the project end user 103 through the project sponsor 105. In such a situation, the partaking entity 101 advances 129 funds to the project sponsor 105 yielding a sufficient rate to accomplish the financial instrument yield objectives. The project sponsor 105 in turn advances 125 funds to the end user 103 under its own terms and conditions. As the project progresses, the end user 103 meets commitments and makes payments 127 to the project sponsor 105. As the project sponsor 105 receives commitments from the end user 103, the project sponsor in turn meets its commitment and makes payments 131 to the partaking entity 101. The partaking entity 101 receives the commitment from the project sponsor 105 in an amount that will ultimately satisfy the commitment made 135 to the investment vehicle 107 by the partaking entity 101. Again, when payments are made 131 from the project sponsor 105, the partaking entity 101 pools 133 the distributions and payments received and, in turn, meets its commitment (net of costs incurred by the partaking entity 101) and makes payments on the financial instruments held by the investment vehicle 107. Again, the investment vehicle 107 further meets its commitment (net of costs incurred by investment vehicle 107) and makes beneficiary payments 137 to the intermediary entity 109 as the beneficiary of the investment vehicle 107.

FIG. 1 does not distinguish between when end user 103 meets commitments due on advances and when the end user 103 makes its terminal commitment on the advances. It should be noted that, generally speaking, the funds advanced 121 at a lower than market yield from the partaking entity 101 to the end user 103 require somewhat insignificant installment commitments (for example, interest only payments) followed by a significant balloon commitment at an agreed to event or term. The final commitment due to the partaking entity 101 is typically near a completion date of the undertaking upon which the advance is based. Much like regular commitments on an ongoing basis, when a final commitment is made by the end user 103, the partaking entity 101 receives 123 the scheduled final commitments in and, in turn, meets 135 its commitments (net of costs incurred by the partaking entity 101) on the financial instruments held by the investment vehicle 107. The investment vehicle 107 will further meet 137 its final beneficiary commitment (net of costs incurred by investment vehicle 107) to the intermediary entity 109 as the beneficiary of the investment vehicle 107.

As an undertaking or project progresses by the end user 103, the project generates externality or, more precisely, the externality has accrued. When an undertaking is completed, social dividend payment is earned, becomes due, and is paid 141. Alternatively, current in-place and unexpired externality from an unrelated or related undertaking may also be proffered 139 by a qualified social dividend recipient and accepted by the intermediary entity 109. Additionally, situations may arise wherein the intermediary entity 109 and the project sponsor 105 are one and the same entity for purposes of distributing an incentive when a social dividend is paid 141. The investment vehicle 107 will be meeting a final commitment (net of costs incurred by investment vehicle 107) and making a final payment 137 to the intermediary entity 109. The intermediary entity 109 then awards 141 the social dividend (net of unreimbursed cost incurred by the intermediary entity 109) to the project sponsor 105. The project sponsor 105 then awards 143 an incentive (net of unreimbursed cost incurred by the project sponsor 105) to the partaking entity 101 for providing 121 the below market advances to the end user 103.

For some projects or undertakings there may not be a need for a project sponsor 105 to convert a 122 proffered externality into a 141 monetized social dividend. When there is no need for a project sponsor 105 the project end user 103 is advanced funds from the partaking entity 101 at a calculated rate sufficient to satisfy the underlying financial instrument yield objectives of the partaking entity 101, after taking account all cost and fee considerations that effect the efficient flow of capital amongst all of the participants, namely the partaking entity 101, the investment vehicle 107, the intermediary entity 109, and the project end user 103.

The beneficiary outflow in the form of payments made 137 from the investment vehicle 107 to the beneficiary 109 as well as the social dividend outflow 141 from the intermediary entity 109 will now be discussed in greater detail as they relate to one of the principles of operation of the externality monetization system 100. In particular, these payments from the investment vehicle 107 to the intermediary entity 109 are included in the concept of the intermediary being considered a bank of externality paying a social dividend evidenced by a certificate that was issued for a monetizable externality 122.

As discussed above, the intermediary entity 109 accepts a deposit of externality when the intermediary entity certifies 122 a proffered externality as monetizable. The certification is evidence that a receivable is held by the intermediary entity 109 that is the externality banker. One might then question when exactly the receivable becomes cash, so to speak. The answer is that the receivable becomes cash when payments are made 137 from the investment vehicle 107 and/or sourced elsewhere.

Payments made from the investment vehicle 107 are not necessarily tied to any particular project. More precisely stated, the investment vehicle 107, in most cases, does not receive payments on financial instruments related to particular projects. Thus, termination payments or final payments made to the intermediary entity 109 are not necessary designed to convert a particular receivable into cash. Rather, substantial payments from the investment vehicle 107 are used by the intermediary 109 to extinguish its commitments to pay social dividend to project sponsors 105 and in some cases the partaking entity 101 directly.

The ongoing payments from the investment vehicle 107 that convert receivables into cash at the intermediary entity 109 and the ongoing payment 141 of the social dividends by the intermediary entity 109 reflect a system of deposits and withdrawals at a banking or savings institution. As disclosed herein, certified monetizable externality deposits 122 are received from many depositors, and honored as social dividend withdrawals 141 from mingled cash funds on hand sourced from ongoing 137 beneficiary receipts and other funding initiatives of the intermediary entity 109. That is to say the externality 122 is accepted as a non cash deposit, and a cash withdrawal 141 is made in the form of a social dividend.

Returning to the direct discussion of FIG. 1, it should be noted that the project sponsor 105 negotiates the incentive to be paid separately and irrespective of the social dividend, since it may have other means to source funds. However, the project sponsor 105 may take the social dividend or other sources of funds into account when negotiating the incentive payment. That is to say, the social dividend and the incentive payment are independent of each other since undertakings and projects are based on the community need rather than maximizing the social dividend.

The project sponsor 105 may also look to the social dividend as a means to cover its costs. If the partaking entity 101 has made 129 advances at a rate sufficient to meet its financial instrument obligations, then generally no incentive is due to the partaking entity 101, who has been receiving 131 normal payments from the project sponsor 105. In such a scenario, the project sponsor 105 would keep an incentive contained in the social dividend paid 141 by the intermediary entity 109. In a hybrid situation, if the partaking entity 101 has made 129 advances at a rate not sufficient to meet its financial instrument obligations, then an incentive may be necessary to induce the partaking entity 101 into advancing funds.

Lastly, there may be a situation where the partaking entity 101 advances funds to an end user 103 at either above-market or below-market yield, without any sponsor 105 proffering the externality to the intermediary 109. That is to say, the externality can be considered to be proffered by the end user 103. In those instances, the social dividend would be payable by the intermediary 109 to the end user 103. The end user 103 would then pay the incentive as outflow 123 to the partaking entity 101, in those instances where the advanced funds from the partaking entity 109 to the end user 103 were below market value. In those instances where the advanced funds from the partaking entity 101 to the end user 103 were above market value, a portion or all of the incentive paid by the intermediary may be kept by end user 103, similar to the situations described above.

FIG. 2 is a block diagram illustrating a network configuration of a computer based system 200 for monetizing an externality and incentivizing private funding of an undertaking or project related to the externality. The externality monetization system 200 includes a computer system for implementing the functionality of the partaking entity 203, a computer system for implementing the functionality of the project end user 211, a computer system for implementing the functionality of the project sponsor 209, a computer system for implementing the functionality of the intermediary entity 207, and a computer system for implementing the functionality of the investment vehicle 205.

The computer systems 203, 205, 207, 209, and 211 communicate with each other over a network such as the Internet, an intranet, or other network 201. Each computer system 203, 205, 207, 209, and 211 can be programmed to operate in automated fashion, and also has an analog or a graphic user interface such as Outlook and Windows such that users can control computer systems 203, 205, 207, 209, and 211. Each computer system 203, 205, 207, 209, and 211 includes at least a central processing unit (CPU) with data storage such as disk drives, the number and type of which are variable. In each computer system 203, 205, 207, 209, and 211, there might be one or more of the following: a floppy disk drive, a hard disk drive, a solid state drive, a CD ROM or digital video disk, or other form of digital recording device.

Each computer system 203, 205, 207, 209, and 211 may include one or more displays upon which information may be displayed. Input peripherals, such as a keyboard and/or a pointing device, such as a mouse, may be provided as input devices to interface with the CPU. To increase input efficiency, the keyboard may be supplemented or replaced with a scanner, card reader, or other data input device. The pointing device may be a mouse, touch pad control device, track ball device, or any other type of pointing device.

Each computer system 203, 205, 207, 209, and 211 interconnects peripherals previously mentioned herein through a bus supported by a bus structure and protocol. The bus serves as the main source of communication between components of each computer system 203, 205, 207, 209, and 211. The bus in each computer system 203, 205, 207, 209, and 211 may be connected via an interface.

The CPU of each computer system 203, 205, 207, 209, and 211 performs the calculations and logic operations required to execute the functionality of each computer system as described above with respect to FIG. 1 as well as further below with respect to FIGS. 3-5. The functionality of each computer system 203, 205, 207, 209, and 211 may be processed in an automated fashion such that relevant data is processed without user administrator assistance or intervention. Alternatively or additionally, the functionality of each computer system 203, 205, 207, 209, and 211 may be processed in a semi-automatic fashion with intervention from a user administrator at one or more of the computer systems 203, 205, 207, 209, and 211. Implementing, processing, and executing the functionality of each computer system 203, 205, 207, 209, and 211 described in this disclosure with respect to FIGS. 1 and 3-5 is within the purview and scope of one of ordinary skill in the art, and is not discussed in detail herein.

Each computer system 203, 205, 207, 209, and 211 may be implemented as a distributed computer system or a single computer. Similarly, each computer system 203, 205, 207, 209, and 211 may be a general purpose computer, or a specially programmed special purpose computer. Moreover, processing in each computer system 203, 205, 207, 209, and 211 may be controlled by a software program on one or more computer systems or processors, or could even be partially or wholly implemented in hardware. The computer systems 203, 205, 207, 209, and 211 used in connection with the functionality described with reference to FIGS. 1 and 3-5 may rely on the integration of various components including, as appropriate and/or if desired, hardware and software servers, database engines, and/or other content providers.

Although the computer systems 203, 205, 207, 209, and 211 in FIG. 2 are illustrated as being a single computer, each computer system according to one or more embodiments of the invention is optionally suitably equipped with a multitude or combination of processors or storage devices. For example, each computer illustrated in computer systems 203, 205, 207, 209, and 211 may be replaced by, or combined with, any suitable processing system operative in accordance with the principles of embodiments of the present disclosure, including sophisticated calculators, hand held, smartpads, laptop/notebook, mini, mainframe and super computers, as well as processing system network combinations of the same. Further, portions of each computer system 203, 205, 207, 209, and 211 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems 203, 205, 207, 209, and 211. For example, at least some of the functionality mentioned above could be implemented using Visual Basic, C, C++ or any assembly language appropriate in view of the processor being used. It could also be written in an interpretive environment such as Java and transported to multiple destinations to various users.

As another example, each computer system 203, 205, 207, 209, and 211 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system 203, 205, 207, 209, and 211 may be connected over the Internet, an Intranet, or over a further network 201. Links to the network 201 may also be a dedicated link, a modem over a POTS line, and/or any other method of communicating between computers and/or users.

Each computer system 203, 205, 207, 209, and 211 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked. Succinctly put, the computer systems 203, 205, 207, 209, and 211 of the computer based externality monetization system 200 may implement the functionality of the various embodiments described herein with respect to FIGS. 1 and 3-5 using any imaginable computing environment.

Referring to FIG. 3, a bubble flow chart illustrating a method for monetizing an externality and incentivizing private funding in the form of a financing of an undertaking or project is discussed and described. It should be noted that in the bubble flow chart, if no enumeration is present at a particular arrow connecting two bubbles, this indicates that the method proceeds to the bubble pointed to by the particular arrow. If there is a reference numeral associated with a particular an arrow, the method proceeds as indicated in the discussion below. It should also be noted that similar reference numerals from FIG. 1 are used in FIG. 3 to identify participants of an externality monetization system.

The method starts at step 301, where an investor funds an investment vehicle 107, and proceeds to step 303 where an administrator such as a trustee is appointed as a fiduciary to manage the investment vehicle 107. At step 304, funds are transferred to the partaking entity that is a financing entity 101 which is where the investment vehicle 107 purchases, at step 305, financial instruments from the partaking entity that is a financing entity 101. At step 306, the financial instruments purchased by the investment vehicle 107 through the administrator are transferred to the care of the administrator.

At step 307, the partaking entity that is a financing entity 101 advances funds in the form of a loan to an end user 103. As indicated above, these loan advances are typically at below market terms compared with similar types of financial loan instruments. At step 309, the end user 103 makes installment payments on the loan to the partaking entity that is a financing entity 101. At step 310, the partaking entity that is a financing entity 101 receives the payment from the end user 103 and proceeds at step 315 to pay dividends, interest or interest dividends to the owners of financial instruments, which are investment vehicles 107. At step 317, the investment vehicle 107 pays through the fiduciary administrator, a stated obligation in the form of dividends, interest or interest dividends to the beneficiary intermediary entity 109.

Although no arrow so indicates, the end user 103 repeats making payments against the loan advanced at step 309 until each installment payment is completed prior to what is often a final balloon payment due date. At step 313, the end user 103 makes the final repayment on the loan advance to the partaking entity that is a financing entity 101. The final payment is usually a balloon type payment, as referenced above, along with an interest payment on the loan advanced.

It should be noted that typically at the time final payment on the loan advanced is paid from the end user 103 to the partaking entity that is a financing entity 101, the underlying externality objective is achieved. Thus at step 319, the project sponsor 105 and the intermediary entity 109 complete the social benefit redemption process in that the intermediary entity 109 confirms that the externality objective is achieved to the standards established in the verification process described above.

Once the end user 103 makes a final payment at step 313, the partaking entity that is a financing entity 101 receives the payment at step 312. The partaking entity that is a financing entity 101 at step 321 then makes a redemption payment and settles the financial instruments being held by the investment vehicle 107. As will be seen later with reference to FIG. 5, the redemption payment does not necessarily end all obligations to the financial vehicle 107 from the partaking entity that is a financing entity 101. However, the process of financial instrument redemption is undertaken.

After the partaking entity that is a financing entity 101 makes the redemption payment at step 321, the investment vehicle fulfills its obligation to the intermediary entity 109. Specifically, the administrator as trustee may carry out the duties of the trust and pay a remainder to intermediary entity 109. Of course, once the intermediary entity 109 has received the funds from the investment vehicle 107, it is free at step 325 to pay the social dividend to the project sponsor 105. The project sponsor 105 at step 327 then pays the pre-agreed incentive/reward to the partaking entity that is a financing entity 101 for its participation in low interest lending.

It should be noted that end user 103 has other options beside straight loan repayment of interest and principal to the partaking entity that is a financing entity 101. Specifically, at 311 the end user 103 can refinance the low interest loan from the partaking entity that is a financing entity 101. In this case, the end user 103 will use existing externality as security for additional financing. In such a refinance situation, the new partaking entity that is a financing entity will establish a new loan at step 316 such that the final loan payment to the current partaking entity that is a financing entity 101 occurs at step 313. From there, the remainder of the winding down process in steps 312, 314 and 321-327 occurs.

A working example of an externality monetization system and method will now be described with reference to FIGS. 4 and 5. Referring to FIG. 4, a table 400 illustrating variables 401 and their values 403 for use with a working example of a system and a method for monetizing an externality and incentivizing private financing of an undertaking related to the externality will be described. In this example, the flows have been simplified for purposes of explanation by ignoring costs.

It should be initially noted that as indicated at the top of table 400, that the working example that will now be discussed assumes that an undertaking or project has been fully certified by the intermediary entity 109 as having a proffered externality from which a social dividend can be paid. That is to say, a social dividend amount has been determined. Once such a certification or verification is made, the partaking entity that is a financing entity 101, the end user 103, and the investment vehicle 107 can determine the exact terms of the various agreements. In this instance, a financial instrument is issued for only one undertaking and the pooling of multiple undertakings as described above is ignored. Table 400 presents sample terms.

The partaking entity that is a financing entity 101 receives from the investment vehicle 107 a funded amount 405 to provide to the end user 103 for the project. The funded amount value 407 is $1,000,000. The partaking entity that is a financing entity 101 thus provides $1,000,000 worth of financial instruments to the investment vehicle 107.

The investment vehicle 407 also determines a beneficiary payment amount 409 that is provided to the intermediary entity 109 as the beneficiary of the investment vehicle 407. The beneficiary payment amount value 411 is $900,000. The beneficiary payment amount value 411 might be said to be a lead amount if the investment vehicle 107 is a charitable lead trust.

Another variable that is determined is the rate 413 of unpaid obligation of the investment vehicle 107 to the intermediary entity 109. This rate represents a percentage rate of the unpaid amount of a beneficiary payment that is due to the intermediary entity 109 which is additionally applied to the unpaid balance due. This rate in the United States is known as the Applicable Federal Rate (AFR) rate. The AFR rate 415 in table 400 is 1.00%.

The next variable to be determined is annual yield 417 that will be paid on the financial instruments purchased from the partaking entity that is a financing entity 101 by the investment vehicle 107. The annual yield value 419 is set to 29%. The balloon payment variable 421 is the final principal amount due to the partaking entity that is a financing entity 101 from the end user 103, which should approximately be timed to be due at completion of a project or undertaking The balloon payment value 427 due to the partaking entity that is a financing entity 101 is $1,000,000.

As mentioned throughout this disclosure, the partaking entity 101 can make below market advances, such as low interest loans, to the end user 103. As such it should be appreciated that the annual rate of interest variable 425 is set to a low value. In the current working example, the annual rate of interest value 427 is set at 1.80%.

As mentioned above, an undertaking or project must be fully certified by the intermediary entity 109 as having a proffered externality from which a social dividend can be paid prior to any other variables being set. In the current working example, the determined monetization 429 of an externality that will be paid as a social dividend value 431 is set as $920,000. It should be noted that the proffered externality could have a value that exceeds $920,000, but only a portion worth $920,000 will be paid as the social dividend. The incentive 433 paid to the partaking entity that is a financing entity 101 for making below market advances to the end user 103 must also be set. The incentive paid value 435 in the current example is set to $875,000.

The last variable to be set is the termination and final payment 437 to be made to the investment vehicle 107 when it is required. That is to say, often times an investment vehicle will be terminated and funds returned to the investor or other named beneficiary (who is not the intermediary). In this example, when the investment vehicle is terminated, a termination payment value 439 of $930,000 will be returned by the administrator to a named beneficiary of the funding investor whose objective it is to achieve a financial goal, as discussed above.

Referring now to FIG. 5, which is a table 500 of calculations, using the variables and values of FIG. 4, a working example of a system and method for monetizing an externality and incentivizing private funding of an undertaking or project related to the externality, is discussed and described. It should be noted that each row of table 500 is read from left to right, and then the rows are read from top to bottom. In other words, the data in the table should be read as if each column for the partaking entity that is a financing entity 501, financial instruments 503, investment vehicle 505, intermediary 507, and sponsor 509 were disposed on a single row, extending left to right. Entries are discussed at intersections of years 0, 1, 2, 3(A), and 3(B) with the columns 501A-509D.

Specifically then, at year 0 and column 501C, the loan balance value 421 due to the partaking entity that is a financing entity from the end user is set to $1,000,000. At year 0 and column 501D, the incentive receivable value 435 due is $875,000. At year 0 and column 503A, the amount due 407 from the partaking entity that is a financing entity on the financial instruments is $1,000,000. At year 0 and column 503D, the unpaid balance on the financial instrument is $1,000,000.

At year 0 and column 505A, the amount unpaid 411 that is due to the beneficiary intermediary from the investment vehicle is $900,000. At year 0 and column 505D, the ending balance due from the intermediary to the beneficiary is $900,000. At year 0 and column 507B, the redeemable social dividend 431 due from the intermediary to the sponsor is $920,000. At year 0 and column 509A, since no social dividend has been paid, the receivable social dividend due the project sponsor is $920,000.

At the year 1 and column 501A, the interest receivable due to the partaking entity that is a financing entity is 18,000, which is $1,000,000*1.8%. At year 1 and column 501B, an interest payment is received from the end user 103 which is ($18,000). At year 1 and column 501C, the loan balance value due to the partaking entity that is a financing entity from the end user remains at $1,000,000. At year 1 and column 501D, the incentive receivable due to the partaking entity that is a financing entity remains at $875,000. At year 1 and column 501F, the interest received by the partaking entity that is a financing entity is passed through as a dividend paid on the financial instruments in the amount of ($18,000).

At year 1 and column 503A, the amount due from the partaking entity that is a financing entity on the financial instruments remains at $1,000,000. At year 1 and column 503B, a dividend due on the financial instruments is $290,000, which is $1,000,000*29%. At year 1 and column 503C, the dividend paid at year 1 and column 501F is recorded as ($18,000). At year 1 and column 503D, the unpaid balance on the financial instruments is $1,000,000+$290,000−($18,000)=$1,272,000.

At year 1 and column 505A, the amount unpaid that is due to the beneficiary intermediary from the investment vehicle is rolled over from the ending balance due at year 0 and column 505D, and is $900,000. At year 1 and column 505B, the accrued interest on the unpaid beneficiary balance is $900,000*1%=$9,000. At year 1 and column 505C, an ($18,000) payment is passed through to the beneficiary intermediary. At year 1 and column 505D, the ending balance due to the beneficiary intermediary is calculated as $900,000+$9,000−($18,000)=$891,000.

At year 1 and column 507A, the cash balance at the intermediary is simply the received beneficiary payment of $18,000. At year 1 and column 507B, the redeemable social dividend due from the intermediary to the project sponsor remains at $920,000. At year 1 and column 507D, the cash balance at the intermediary is $18,000. At year 1 and column 509A, since no social dividend has been paid, the receivable social dividend due to the project sponsor is $920,000.

At year 2 and column 501A, an interest receivable due to the partaking entity that is a financing entity is 18,000, which is $1,000,000*1.8%. At year 2 and column 501B, an interest payment is received from the end user 103 which is ($18,000). At year 2 and column 501C, the loan balance value due to the partaking entity that is a financing entity from the end user remains at $1,000,000. At year 2 and column 501D, the incentive receivable due to the partaking entity that is a financing entity remains at $875,000. At year 2 and column 501F, the interest received by the partaking entity that is a financing entity is passed through as a dividend paid on the financial instruments in the amount of ($18,000).

At year 2 and column 503A, the amount due from the partaking entity that is a financing entity on the financial instruments, and rolled over from year 1 and column 503D, is at $1,272,000. At year 2 and column 503B, a dividend receivable on the financial instruments is $290,000, which is $1,000,000*29%. At year 2 and column 503C, the dividend receivable is recorded as ($18,000). At year 2 and column 503D, the unpaid balance on the financial instruments is $1,272,000+$290,000−($18,000)=$1,544,000.

At year 2 and column 505A, the amount unpaid that is due to the beneficiary intermediary from the investment vehicle is rolled over from the ending balance due at year 1 and column 505D, and is $891,000. At year 2 and column 505B, the accrued interest on the unpaid beneficiary balance is $891,000*1%=$8,900. At year 2 and column 505C, an ($18,000) payment is paid to the beneficiary intermediary. At year 2 and column 505D, the ending balance due to the beneficiary intermediary is calculated as $891,000+$8,910−($18,000)=$881,910.

At year 2 and column 507A, the cash balance at the intermediary is simply the two received beneficiary payment of $18,000 totaling $36,000. At year 2 and column 507B, the redeemable social dividend due from the intermediary to the sponsor remains at $920,000. At year 2 and column 507D, the cash balance at the intermediary is $36,000. At year 2 and column 509A, since no social dividend has been paid, the receivable social dividend due the sponsor is $920,000.

It should be noted that at year 3, the balloon payment on the loans from the partaking entity that is a financing entity to the end user become due and payable in whole to the partaking entity that is a financing entity. This fact will be accounted for in year 3(A). However, starting at year 3(A) and column 501A, the interest receivable to the partaking entity that is a financing entity from the end user remains $18,000. At year 3(A) and column 501B, the lump sum payment of ($1,000,000) in principal and ($18,000) interest is received for a total of ($1,018,000). At year 3(A) and column 501C, the loan balance value due to the partaking entity that is a financing entity from the end user is reduced to zero as the payment on the loan has been received. At year 3(A) and column 501D, the incentive receivable due to the partaking entity that is a financing entity remains at $875,000. At year 3(A) and column 501F, the interest received by the partaking entity that is a financing entity and the lump sum payment of principal due are passed through as a dividend paid as well as a payment on the principal owed to the financial instruments although this latter amount is not indicated in the column header. The amount paid on the financial instruments at year 3(A) and column 501F is ($1,018,000).

At year 3(A) and column 503A, the amount due from the partaking entity that is a financing entity on the financial instruments, and rolled over from year 2 and column 503D, is $1,544,000. At year 3(A) and column 503B, a dividend receivable on the financial instruments is $290,000, which is $1,000,000*29%. At year 3(A) and column 503C, the dividend and principal paid at year 3(A) and column 501F is recorded as ($1,018,000). At year 3(A) and column 503D, the unpaid balance on the financial instruments is $1,544,000+$290,000−($1,018,000)=$816,000.

At year 3(A) and column 505A, the amount unpaid that is due to the beneficiary intermediary from the investment vehicle is rolled over from the ending balance due at year 2 and column 505D, and is $881,910. At year 3(A) and column 505B, the accrued interest on the unpaid beneficiary balance is $881,910*1%=$8,819. At year 3(A) and column 505C, the investment vehicle having received a ($1,018,000) payment at year 3(A) and column 503C proceeds to settle with the intermediary by paying the full beneficiary balance due which is ($890,729), which is ($881,910)+(8,819). At year 3(A) and column 505D, the beneficiary balance due to the intermediary has been reduced to zero (0). At year 3(A) and column 505F, the investment vehicle is holding ending cash that is equal to the $1,018,000 previously received−the settlement payment at year 3(A) and column 505B of ($890,729)=$127,271.

At year 3(A) and column 507A, the cash balance at the intermediary is now the rolled over ending balance from year 2 and column 507D of $36,000+$890,729 received in the payment at year 3(A) and column 505C=$926,729. At year 3(A) and column 507B, the redeemable social dividend due from the intermediary to the sponsor remains at $920,000. However, at year 3(A) and column 507C, the intermediary pays the ($920,000) that is due to the sponsor. Thus at year 3(A) and column 507D, the cash balance and/or profit on hand is the $926,729 totaled at year 3(A) and column 507A−the $920,000 paid at year 3(A) and column 507C=$6,729.

At year 3(A) and column 509A, the receivable social dividend due the sponsor is $920,000. However at year 3(A) and column 509B, the social dividend received is also $920,000. Next at year 3(A) and column 509C, the sponsor pays the $875,000 incentive for making low interest loans to the partaking entity that is a financing entity. The sponsor at year 3(A) and column 509D ends the cycle with an ending cash balance of $920,000 received at year 3(A) and column 509(B)−the paid $875,000=$45,000.

Several obligations remain unsatisfied after the partaking entity that is a financing entity is paid the incentive at year 3(A) and column 509C. Therefore, at year at year 3(B) and column 501D, the incentive receivable becomes zero. At year 3(B) and column 501E, the incentive received is raised to $875,000. However, the $816,000 owing on the financial instruments from year 3(A) and column 503D must be paid, so at year 3(B) and column 501F, the financing entity makes a payment of ($816,000) to settle the financial instruments. At year 3(B) and column 501G, the ending profit/cash balance of the partaking entity that is a financing entity is $59,000 which is simply the incentive received at year 3(B) and column 501E of $875,000−the settlement of $816,000 at year 3(B) and column 501F=$59,000.

At year 3(B) and column 503A, the amount due from the partaking entity that is a financing entity is $816,000 which is of course paid by the partaking entity that is a financing entity at year 3(B) and column 501F. At year 3(B) and column 503C, the financial instrument passes through the dividend to the financial vehicle of $816,000 such that at year 3(B) and column 503D, there is a zero balance in the financial instruments.

At year 3(B) and column 505E, the terminal payment of ($930,000) is paid to the creating investor or a named beneficiary other than the intermediary out of the $816,000 received from the payment at year 3(B) and column 503C and the $127,271 on hand at year 3(A) and column 505F. Thus, the remaining balance in the investment vehicle at year 3(B) and column 505F is $943,271 (which is $816,000+$127,271)−the $930,000 paid to investor at year 3(B) and column 505E=$13,271. Of course, as can be seen at year 3(B) and column 507C/507D, both the beginning and ending cash balance in the intermediary remains at $6,729. It should be noted that in some cases, the investment vehicle may simply continue to exist without a return to an investor, which in this case would result in an ongoing cash balance of $943,271.

In this disclosure, the terms “funding” or “advancing funds” or “funds advanced,” and the like, for undertakings and projects may encompass all forms of private financial participation that involves a transfer of funds. These terms should not be construed as being limited to lending activities.

In this disclosure, the term “payments” should be understood to encompass all forms of inflows on the part of the recipient, including but not limited to principal, income, expense reimbursement, or any other form known or unknown that results in an inflow to the recipient entity.

The term “payments” should also be understood all forms of outflows on the part of the payer, including but not limited to principal, income, expense reimbursement, or any other form known or unknown that results in an outflow to the payer entity.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method, comprising:
calculating by an intermediary, using a computing apparatus, an estimated social dividend achieved as a monetization of an externality accruing to the public;
advancing funds, by a partaking entity, related to the externality;
paying, by the intermediary, the social dividend as estimated; and
receiving, by the partaking entity, an incentive for advancing the funds related to the externality.

2. The method according to claim 1, further comprising:
issuing, by the partaking entity, financial instruments held in an investment vehicle which establishes the intermediary as a beneficiary.

3. The method according to claim 1, further comprising:
satisfying balances due of the advanced funds to the partaking entity.

4. The method according to claim 3, further comprising:
settling, by the partaking entity, balances due on the financial instruments held by the investment vehicle; and
settling, by the investment vehicle, balances due to the intermediary as a result of the establishment of the intermediary as the beneficiary of the investment vehicle.

5. The method according to claim 1, further comprising:
settling, by the partaking entity, balances due on the financial instruments held by the investment vehicle; and
settling, by the investment vehicle, balances due to the intermediary as a result of the establishment of the intermediary as the beneficiary of the investment vehicle.

6. The method according to claim 1, wherein
paying the social dividend by the intermediary includes paying the social dividend to a sponsor responsible for identifying an undertaking having the externality.

7. The method according to claim 6, further comprising:
paying, by the sponsor, an incentive to the partaking entity for the externality achieved.

8. The method according to claim 1, wherein
paying the social dividend by the intermediary includes paying an incentive to the partaking entity for the externality achieved.

9. The method according to claim 2, wherein
the investment vehicle is any entity entrusted with protecting, in a fiduciary manner, the interests of the intermediary.

10. The method according to claim 2, wherein
the investment vehicle is a split-interest charitable trust.

11. The method according to claim 10, wherein
the split interest charitable trust is one of a charitable remainder trust and a charitable lead trust and a hybrid charitable instrument.

12. The method according to claim 2, wherein
the financial instruments held in the investment vehicle are obligations of the partaking entity.

13. The method according to claim 2, wherein
the financial instruments held in the investment vehicle are equity interests.

14. The method according to claim 1, wherein
the intermediary is any entity entrusted with protecting, in a fiduciary manner, the externality.

15. The method according to claim 14, wherein
the intermediary is a trust.

16. The method according to claim 14, wherein
the intermediary is a corporation.

17. The method according to claim 14, wherein
the intermediary is a pass-thru entity.

18. The method according to claim 14, wherein
the intermediary is a non-governmental organization

19. The method according to claim 14, wherein
the intermediary entity is a governmental organization.

20. The method according to claim 14, wherein
the intermediary is registered as a 501(c)(3) charity.

21. The method according to claim 1, further comprising:
receiving, by the partaking entity, collateral for advancing funds.

22. The method according to claim 1, wherein
the partaking entity advances funds related to the externality at a rate which is lower than a market average for similar types of advances, for which the partaking entity receives the incentive.

23. The method according to claim 6, wherein
the partaking entity advances funds to the sponsor at a rate which is at or above a market average for similar types of advances;
the sponsor further advances funds at its own terms and conditions for similar types of advances; and
the sponsor, rather than the partaking entity, receives the incentive.

24. A method, comprising:
receiving information about an externality accruing to the public from an undertaking; and
calculating with a computing apparatus, based on the received information, a social dividend as a monetization of at least a portion of the externality.

25. The method according to claim 24, further comprising:
paying the social dividend.

26. The method according to claim 25, wherein:
any portion of the externality not paid as the social dividend becomes a resource for a future social dividend.

27. The method according to claim 2, wherein
the investment vehicle is a trust.

28. The method according to claim 2, wherein
the investment vehicle is a corporation.

29. The method according to claim 2, wherein
the investment vehicle is a pass-thru entity.

30. The method according to claim 2, wherein
the investment vehicle is a non-governmental organization.

31. The method according to claim 2, wherein
the investment vehicle entity is a governmental organization.

32. The method according to claim 2, wherein
the investment vehicle is registered as a 501(c)(3) charity.

33. The method according to claim 2, wherein
the investment vehicle is a special purpose vehicle.

34. The method according to claim 2, wherein
the investment vehicle is a special purpose entity.

35. The method according to claim 2, wherein
the investment vehicle is a split-interest trust.
